(19) United States
(12) Patent Application Publication
(10) Pub. No.: US 2016/0188642 A1
(43) Pub. Date: Jun. 30, 2016

(54) INCREMENTAL UPDATE OF EXISTING PATENTS WITH NEW TECHNOLOGY

(71) Applicants: Debmalya Biswas, Lausanne (CH); Julian Nolan, Switzerland (CH); Matthew John Lawrenson, Bussigny-pres-de-lausanne (CH)

(72) Inventors: Debmalya Biswas, Lausanne (CH); Julian Nolan, Switzerland (CH); Matthew John Lawrenson, Bussigny-pres-de-lausanne (CH)

(21) Appl. No.: 14/585,832

(22) Filed: Dec. 30, 2014

(51) Int. Cl. G06F 17/30; G06F 17/22; G06F 17/24

(52) U.S. Cl. CPC G06F 17/30321; G06F 17/30011; G06F 17/30876; G06F 17/24; G06F 17/2205; G06F 17/30595

(57) ABSTRACT

A computer-implemented method for combining a primary document with one or more candidate documents, the method comprising: extracting process steps disclosed in the primary document and extracting candidate process steps disclosed in the one or more candidate documents; constructing a primary data structure corresponding to the primary document, wherein the primary data structure comprises interconnected nodes and each node corresponds to an extracted process step disclosed in the primary document; identifying one or more candidate processes to combine with the primary data structure; and inserting the one or more identified candidate process steps into the primary data structure.

### FIELD OF THE TECHNOLOGY

The present disclosure relates generally to the field of computer assisted innovation, particularly to the automated identification of processes in documents that are suitable for combining with the disclosures of existing processes.

### BACKGROUND

A considerable proportion of new inventions and patents can be characterised as an incremental updates to existing ideas or concepts. Such incremental updates may, for example, improve the efficiency of the process, provide a hitherto unknown use for the process in a different field, or solve a problem present in the existing concept.

While such incremental improvements may only comprise small alterations to existing designs, they can have a great impact on the scope and commerciality of the invention. Furthermore, such incremental updates may require a significant inventive step to reach the improved process, as the change may not have been obvious to the skilled person.

While a person skilled in a particular field will be aware of existing developments within their field, they may be entirely unaware of developments in other, unrelated fields. Therefore, many inventions originate from an inventor being aware of a concept in a different field and identifying that the concept is can be applied to their own field to overcome a similar problem.

However, given the vast volume of new developments and information published in each field, the skilled person would struggle to keep up with developments in their own field, let alone review developments in unrelated fields. Therefore, the act of identifying a disclosure that can be repurposed to solve a problem in an unrelated field typically requires an inventive leap and is often classified as an invention.

Given that the main barrier to identifying solutions in unrelated fields is the inability of the skilled person to process the large amounts of information available, attempts have been made to use computers to assist inventors in identifying new innovations. However, while computers can perform tasks orders or magnitudes faster than the average person, the individual tasks the computer can perform are relatively simple compared to the complexities of performing inventive leaps. Therefore, existing computer assisted innovation solutions return large numbers of possible solutions with limited guidance on which solution is most promising, and as a result, still requires significant user intervention.

There is therefore a need for improved systems of computer assisted innovation that can provide fast and relevant results to the user.

### SUMMARY

According to one aspect of the present invention, there is provided a method comprising: extracting process steps disclosed in a primary document and extracting candidate process steps disclosed in one or more candidate documents; constructing a primary data structure corresponding to the primary document, wherein the primary data structure comprises interconnected nodes and each node corresponds to an extracted process step disclosed in the primary document; identifying one or more candidate processes to combine with the primary data structure; and inserting the one or more identified candidate process steps into the primary data structure.

By constructing a primary data structure of interconnected nodes, the proposed method can distil a verbose document down to its essence in a format suitable for fast, efficient and complex analysis by a computer system.

Subsequently processing one or more candidate documents and identifying processes that can be combined with the primary data structure allows the proposed method to find possible solutions disclosed in other documents that can be incorporated into the existing process, to result in an entirely new process. Using this structured approach, the proposed solution can quickly and efficiently identify candidates for combination with a primary document.

In some example embodiments, said identifying comprises determining the uniqueness of candidate process steps with respect to nodes in the primary data structure. Determining the uniqueness of candidate process steps with respect to nodes in the primary data structure enables the identification of process steps that will provide a significant departure from existing teachings, thereby having a greater chance of novelty.

In some example embodiments, determining the uniqueness of candidate process steps comprising tagging each node in the primary data structure and each candidate process step with a logic step, and calculating the number of unique logic steps in a the candidate process steps compared to the logic steps in the nodes in the primary data structure. Tagging the process steps in this way allows for simpler and faster comparison of steps.

In some example embodiments, the inserting one or more candidate process steps comprises inserting details of the candidate process steps into one or more nodes of the primary data structure. Inserting details of candidate process steps into nodes of the primary data structure allows for updates of the data structure without fundamental changes to the structure.

In some example embodiments, the inserting one or more candidate process steps comprises forming new nodes corresponding to the candidate process steps and interconnecting said new nodes with the nodes in the primary data structure.

In some example embodiments, interconnecting said new nodes with the nodes in the primary data structure comprises replacing a sequence of one or more nodes in the primary data structure with the new nodes.

In some example embodiments, said identifying comprises determining the number of nodes in the sequence of nodes in the primary data structure replaced by the new nodes. By determining the number of nodes in the primary data structure replaced by new nodes, it is possible to get a measure of how large an impact the replacement has had on the overall structure, and how much more efficient the structure is made through the reduction of total steps.

In some example embodiments, the method further comprises determining input and output data for each extracted process step and each candidate process step, and for each candidate document: selecting a start node in the primary data structure corresponding to the process step having a greatest overlap of input data with input data in the candidate process steps; selecting an end node in the primary data structure corresponding to the process step having a greatest overlap of output data with output data in the candidate process steps; wherein the sequence of nodes defined by the selected start node and end node is the sequence of nodes replaced by the new nodes. Comparing input and output data in a candidate document with input and output data in a primary data structure is an efficient way of identifying nodes in the primary data structure that can be replaced or enhanced by the disclosure of the candidate document.

In some example embodiments, the determining input and output data for each extracted process step and each candidate process step further comprises tagging each extracted process step and each candidate process step with input and output data. Tagging the input and output data in this way allows for simpler and faster analysis and comparisons.

In some example embodiments, said identifying one or more candidate process steps comprises calculating a score for each of the one or more candidate documents, and identifying one or more candidate process steps from the candidate document with a highest score. Calculating scores allows for the rankings of combinations thereby providing more useful input to the user.

In some example embodiments, the score can be based on any one or more of: the uniqueness of process steps, and the number of nodes in the primary document replaceable by process steps. Having a score based on uniqueness of process steps allows the score to reflect how large a change the combination may have on the primary data structure. Having a score based on number of nodes in the primary document that are replaceable by process steps allows the score to reflect how large a change the combination may have on the primary data structure, and indicates possible efficiencies through reduced steps.

In some example embodiments, the method further comprises: after inserting the one or more candidate process steps into the primary data structure, generating a new document disclosing process steps corresponding to the primary data structure.

In some example embodiments, the method further comprises: after inserting the one or more candidate process steps into the primary data structure, outputting the primary data structure as a candidate innovation.

In some example embodiments, said the extracted process extracting process steps disclosed in the primary document comprises performing image analysis on a technical drawing in the primary document, wherein said technical drawing is preferably a flowchart. Performing analysis on flowcharts is advantageous, as they are simple to analyse through known image analysis techniques, and the structure of flowcharts are particularly suitable for analysis by computer systems.

In some example embodiments, the primary document is a patent document, and the method further comprises: receiving a plurality of patent documents; and repeating the method of any preceding claim on each patent document as a primary document.

According to another aspect of the present invention, there is provided a computer system comprising: one or more processors; and memory comprising instructions which when executed by the one or more processors cause the computer system to perform any of the aforementioned methods.

According to another aspect of the present invention, there is provided a computer readable medium having computer executable instructions stored thereon for implementing any of the aforementioned methods.

### BRIEF DESCRIPTIONS OF DRAWINGS

Examples of the present proposed apparatus will now be described in detail with reference to the accompanying drawings, in which:

FIG. 1 shows an example primary document and a flowchart extracted from the primary document;

FIG. 2 illustrates the process of extracting information from candidate documents;

FIG. 3 illustrates the process of calculating a score for a candidate document;

FIG. 4 shows a document that has been merged in accordance with an example embodiment;

FIG. 5 is an example flowchart extracted from a primary document;

FIG. 6 illustrates an extraction and analysis of data from a candidate document;

FIG. 7 illustrates the process of matching disclosures from a candidate document and a primary document;

FIG. 8 is a flowchart showing the result of combining a flowchart with information in a candidate document;

FIG. 9 illustrates an extraction and analysis of data from a candidate document;

FIG. 10 illustrates the process of matching disclosures from a candidate document and a primary document; and

FIG. 11 is a flowchart showing the result of combining a flowchart with information in a candidate document.

### DETAILED DESCRIPTION

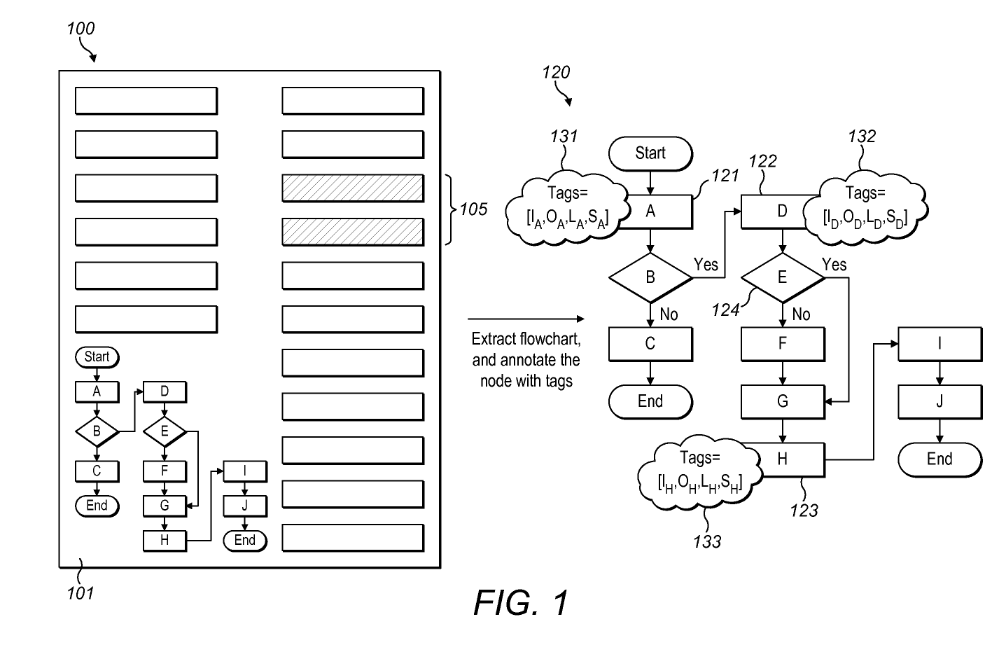

Reference will now be made to FIG. 1 which shows an example technical document 100 having the contents of a technical drawing 101 extracted from it.

The technical document 100 may be any source of information, preferably available in a digital medium. The technical document 100 contains details of processes, and it is envisioned that such processes may span a variety of fields, such as manufacturing processes, steps in a computer program and chemical synthesis instructions. This disclosure may be in the form of text passages 105, and/or preferably contains a technical drawing 101.

The technical document 100 may be a patent or a research article, for example. Preferably, the technical document will be directed to solving a problem, wherein the solution to the problem is presented in the form of a flowchart describing the process or data flow.

The technical drawing may be an illustration of the process being disclosed, and illustrates the individual steps and possible outcomes of the process. In the example provided, document 100 is a patent document, the technical drawing 101 is a flowchart of a patented process, and text passages 105 are the accompanying description on the flowchart.

An initial step of the proposed solution is to extract the process information disclosed in the technical document 100. This extraction may comprise performing image analysis on the flowchart 101 to identify individual processes of the flowchart 101, what type of process they are based on their represented shapes, and how they connect with other processes in the flowchart. The accompanying text passages 105 may be used to provide further details of the process steps extracted from the flowchart 101. If no technical drawings are available in the document, the text passages 105 may be the sole source of information for process extraction. The text passage 105 that corresponds to the flowchart 101 may be identified by analysing a figure number of the flowchart 101 and locating text passages referencing the same figure number.

A flowchart 101 can be generalised as a set of m nodes, and may be represented by object F:

F:={(n₁,t₁),(n₂,t₂), . . . ,(nₘ,tₘ)}

Where the pair (nᵢ, tᵢ) refers to the i^{th} node nᵢ in F, and the associated text tᵢ may be the text in the illustrated flowchart node, or the text in a corresponding text passage, or a combination thereof.

The extracted process steps may be used to construct a data structure 120 representing the process described in the technical document 100. The data structure 120 may comprise a plurality of nodes, wherein each node (such as 121, 122 and 123) represents a process step, and the connections between nodes indicates how the process flows. Some nodes may be identified as being different types of nodes from others in the data structure 120, for example some nodes 124 may represent decision steps in the flowchart, while other nodes 121 may be simpler process steps which take an input, perform a process, and outputs the result of that process to a connected node.

Optionally, the nodes of the data structure 120 may also be annotated or tagged with further information. The tagging of individual nodes may provide more information than was available from the original flowchart figure 101, and may be used for more efficient analysis of the data structure 120 at a later stage.

The tags may include a keyword, group of keywords, pattern, or concept, for example. The extracted tags may be further classified along 4 dimensions to characterize one or more of the flowchart node along 4 descriptive traits.

An Iᵢ:tag may indicate an input data type required by node nᵢ. An Oᵢ tag may indicate an output data type of a node nᵢ to indicate data output from the node as a result of the process performed by the node. The output tag Oᵢ should be equivalent to an input data tag Iᵢ+1 of the next node nᵢ₊₁. An Lᵢ tag may indicate the processing logic of a node nᵢ, and may be, for example, the type of data transformation performed, the hardware or software operation executed, or a manual task or activity performed. An Si tag may indicate the system or infrastructure requirements to provide nᵢ functionality, such as equipment, sensors, hardware and software platforms.

The tagging of each node is not limited to these four types of tags, and each node may be tagged with any one or more of these four types of tags, or none of these types of tags, or may simply have a generic tag with any information available. However, the more structured the tagging is, the more efficient subsequent analysis may be.

An extended workflow indicating the steps of a flowchart and associated tags may be denoted as follows:

F:={(n₁,[I₁,O₁,L₁,S₁],(n₂,[I₂,O₂,L₂,S₂]), . . . ,(nₘ,[Iₘ,Oₘ,Lₘ,Sₘ])}

This extended workflow shows a list of all the tags in the extracted flowchart, along with any tags associated with each node. The extended workflow may be used as the data structure 120, or may be extended further to include the explicit connections between nodes.

The extracting and tagging process is preferably performed automatically by a computer system using image processing techniques and natural language processing. However, the construction of the data structure 120 may involve human intervention where the computer system has inadequately identified or tagged certain nodes.

During the tagging process, priority may be given to nodes associated with processes, and in some embodiments, tagging may only be performed on nodes associated with processes. In the example extracted data structure 120 shown in FIG. 1, three of the nodes, A 121, D 132 and H 133 are shown to have corresponding sets of tags 131, 132 and 133. In this example each of these sets of tags 131, 132 and 133 include the input, output, process, and system tags associated with each of the nodes A 121, D 132 and H 133. In other example embodiments, all the nodes may be tagged.

The document 100 may be a primary document that is provided as an input to the proposed system. This primary document is a document that discloses an original (historic) disclosure of a process, and the proposed system aims to identify processes in other documents that can be combined with the disclosure of the primary document in order to improve it. In the case of the primary document, a complete primary data structure may be automatically constructed, or it may be constructed with some involvement from a user, or it may even be constructed entirely by the user to ensure that the primary data structure reflects the primary document as accurately as possible.

A primary document may contain a plurality of technical drawings such as flow charts. The proposed system may construct a primary data structure that combines all of the flow charts into a single consolidated data structure, or it may create a data structure for each flow chart and perform the subsequent analysis on each individual data structure.

The proposed system may receive several primary documents as input, for example a patent portfolio, or a collection of documents related to a particular field. In such a scenario, the primary data structure may be an aggregate of the disclosures in the collection of documents.

Once a primary data structure has been constructed, the proposed solution may begin identifying possible updates or improvements to the process represented by the primary data structure.

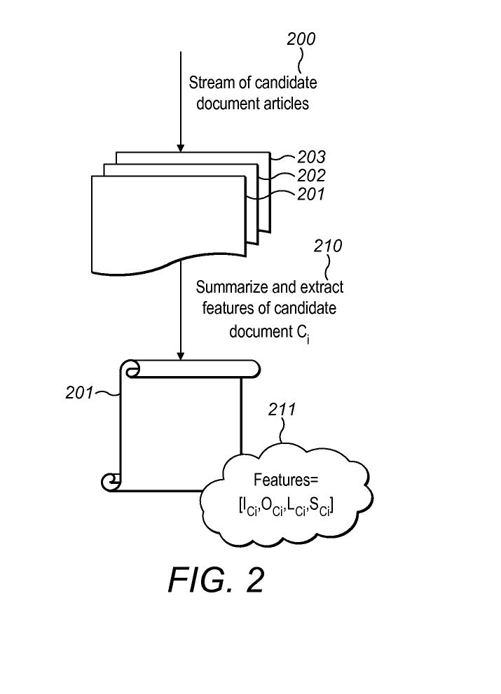

FIG. 2 summarises the process of monitoring one or more candidate documents for information that can be used to update the primary data structure.

In one example embodiment, the proposed system will receive 200 a stream of candidate documents 201, 202 and 203. This stream of candidate documents may be the result of the system continuously monitoring newly published research, articles, product releases, strategy documents, upcoming technologies, and patents, for example. This monitoring may comprise identifying websites of interest, periodically crawling the websites, or monitoring push/notification based systems, such as RSS feeds, to gather newly published articles and documents.

A user may prepare a collection of candidate documents of interest and submit the collection of candidate documents directly to the proposed system. The system may take a single document at a time as input and perform the relevant analysis on the document as it comes in, or it may use parallelisation to improve the time efficiency of the process and maximise the use of available resources.

For each of the received candidate documents, the proposed system may summarise and extract features of the candidate documents 210. This processing of each candidate document may be carried out in a number of ways. For example, the system may search for technical drawings, like flowcharts, and create a data structure in the same way that a primary data structure was constructed from the primary document. The proposed system may identify the key contribution through a summarising function, and identify the process or processes of that key contribution. In a further example embodiment, the proposed system may scan the entire candidate document and extract all features and processes disclosed, and it may either retain the connections between these processes or it may only extract the processes without information on their relationships with other processes.

In the example embodiment illustrated in FIG. 2, the proposed system analyses each candidate document for Conceptually Novel (CN) features. The CN features may be any features that are identified in the candidate document as being particularly crucial to the disclosure; this may be indicated by an abstract or the presence of a flowchart detailing the features, for example.

Each of these features may be further classified into four subsets corresponding to the tags for the primary document. Specifically, these features may be classified into input data types I_{Ci}, output data types O_{Ci}, processing logic L_{Ci}, and system/infrastructure features S_{Ci}. It may not be possible to extract tags corresponding to all 4 description categories in an automated fashion; therefore a semi-automated approach may also be used where missing tags are manually added.

For a stream of incoming candidate documents C₁ 201, C₂ 202 . . . , their features may be extracted and processed in real time leading to the following stream of features:

[I_{C1},O_{C1},L_{C1},S_{C1}],[I_{C2},O_{C2},L_{C2},S_{C2}], . . .

In this example, the set of features [I_{C1}, O_{C1}, L_{C1}, S_{C1}] 211 is related to candidate document C₁ 201, and [I_{C2}, O_{C2}, L_{C2}, S_{C2}] is related to candidate document C₂ 202. In this example embodiment, the extracted features do not include how the individual features relate to one another. Therefore, unlike the primary data structure, the extracted features are stored as a list of available features. Alternatively, these features could be stored in data structures where the connections between features are preserved.

Once a primary data structure has been constructed for the primary document, and one or more features (processes) have been extracted from the one or more candidate documents, the proposed system may attempt to identify if any of the one or more candidate features are suitable for incorporating into the process disclosed in the primary document.

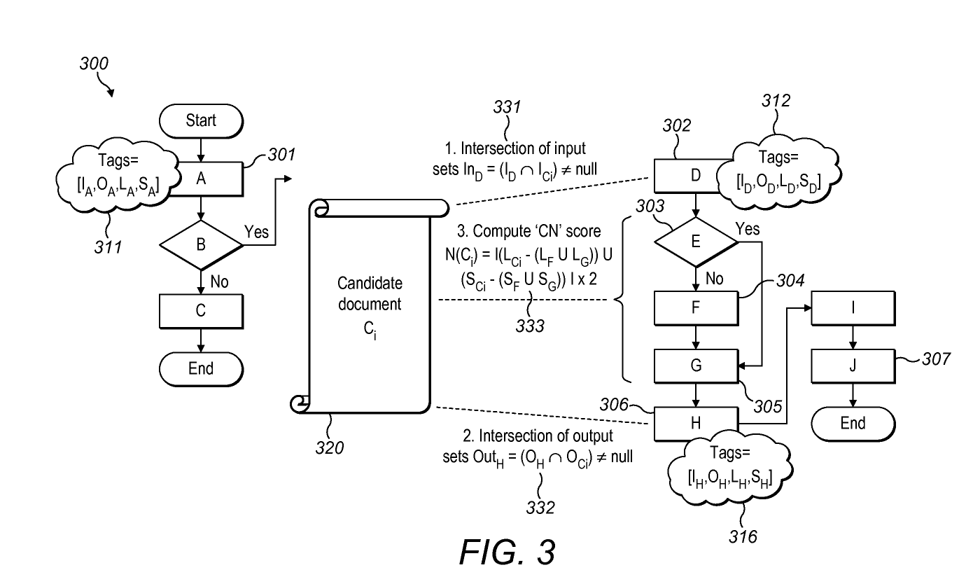

There are several ways envisioned for identifying candidate features to insert into the disclosure of the primary document. FIG. 3 illustrates one example embodiment, where the identifying candidate features involves scoring each candidate document based on how conceptually novel the features are. This score will be referred to as a ‘CN’ Score.

One possible algorithm for computing the ‘CN’ score N(Cᵢ) of a candidate document Cᵢ 320 is envisioned to provide a measure of how unique the candidate features are compared to the primary data structure 300, and how much more efficient the process disclosed by the candidate document 320 is. In this way, multiple candidate documents can be assigned a score and ranked against each other to determine which candidate document disclosure would be the best to combine with the primary document disclosure.

The primary data structure 300 is the same primary data structure illustrated in FIG. 1. Steps 331, 332 and 333 show the steps of an example algorithm that can be performed on the candidate document Cᵢ 320 and primary data structure 300.

The first step 311 of the example algorithm involves matching input nodes to determine which nodes in the primary data structure 300 have comparable inputs to the features of the candidate document 320.

To match the input nodes 311, the algorithm may parse the primary data structure to identify a node nₖ such that there exists a maximal overlap between its input (data type) tags Iₖ and the input features set I_{Ci} of candidate document Cᵢ. Functionally, this step comprises computing the intersection set:

Inₖ=(Iₖ∩I_{Ci})

The intersection set is determined for all nodes nₖ in primary data structure F, thereby identifying the nodes that have similar input tags to the input features of the candidate document. Once the intersection set has been determined, the node nₕ with the maximum cardinality | Inₕ| is selected from the set.

For example, the algorithm may start at node A 301, and for each input tag I_{A} in the set of input tags 311, the algorithm lists which input features of the candidate document Cᵢ matches the input tags I_{A} of node A, and if there is an intersection, records these tags in the intersection set In_{A}. The algorithm repeats this for each node that has input tags, like node D 302 where it determines intersection set In_{D} 331. The algorithm then determines which of the intersection sets has the most elements (i.e. the highest cardinality), thereby indicating which corresponding node has the most input elements in common with the candidate document.

Pre-processing steps may include stemming and extending the tags/features semantically in order to overcome matching issues where different documents refer to the same concept differently. This could be implemented to improve the accuracy of the matching process.

A second step 332 of the example algorithm may be to match output nodes for each candidate document. If an input node has already been selected (nₕ), the algorithm starts at this node, which in this example is node D 302 as the root/starting node for the output matching step 332. The algorithm then traverses the nodes in the primary data structure F that are reachable from nₕ in order to find a node nₖ with the maximum overlap between its output tags Oₖ and the output features set O_{Ci} of candidate document Cᵢ 320.

Functionally, this output matching step 332 comprises traversing the sub-flowchart F′ of F (where F′ is made up of all reachable nodes from nₕ), and computing the intersection set:

Outₖ=(Oₖ∩O_{Ci})

The intersection set Outₖ is determined for all nodes nₖ in sub-flowchart F′, and the node nᵢ with the maximum cardinality |Outₗ| is selected from the set.

The input-matched node nₕ and the output-matched node nₗ, therefore, defines a sub-flowchart Fᵢ that could be replaced by the features of candidate document Cᵢ as they identify a series of m′ nodes that have the same inputs and outputs as the disclosure of Cᵢ.

A third step 333 of the example algorithm may comprise calculating the CN score of a candidate document as a function of the differentiation between the features of the candidate document and the corresponding sub-flowchart Fᵢ. Specifically, for each candidate document Cᵢ, a CN score N(Cᵢ) can be given by the formula:

N(Cᵢ)=|(L_{Ci}−(L₁∪L₂ . . . ∪L_{m′}))∪(S_{Ci}−(S₁∪S₂ . . . ∪S_{m′}))|

This effectively determines how many process features (L_{Ci}) are in the candidate document Cᵢ that are not in the process tags (Lᵢ to L_{m′}) of the sub-flowchart Fᵢ, where m′ is the number of nodes in the sub-flowchart Fᵢ. The formula further determines how many system/infrastructure features (S_{Ci}) are in the candidate document Cᵢ that are not in the system tags (S₁ to S_{m′}) of the sub-flowchart Fᵢ. The CN score is therefore a function of the cardinality of process and system elements that are in the candidate document but not in the sub-flowchart Fᵢ.

Alternatively, the CN score may simply be a function of the number of unique process tags (|(L_{Ci}−(L₁∪L₂ . . . ∪L_{m′}))|), or the number of unique system tags (|(S_{Ci}−(S₁∪S₂ . . . ∪S_{m′}))|).

The CN score may also be a function of the number of nodes being replaced by the disclosure of candidate document Cᵢ, namely the value m′. The CN score may simply be directly related to the number of replaced nodes (i.e. N(Cᵢ)=m′), or the number of replaced nodes may scale the value for uniqueness. For example, in a preferred embodiment the CN score N(Cᵢ) is given by the formula:

N(C)=|(L_{Ci}−(L₁∪L₂ . . . ∪L_{m′}))∪(S_{Ci}−(S₁═S₂ . . . ∪S_{m′}))|×m′

This formula accommodates for both quantitative and qualitative aspects by considering not only the number of nodes (m′) of the primary data structure that could be replaced by the technology proposed in Cᵢ, but also the ‘semantic’ difference between the features in Cᵢa and the tags of nodes in Fᵢ. Combinations that replace many nodes are given higher scores because it shows that the combination is having a greater effect on the original process, and it may also indicate greater efficiencies in a simplified process with fewer steps.

Step 333 in FIG. 3 shows an example computation of CN score. In this example, the sub-flowchart Fᵢ of nodes that can be replaced by the contents of Cᵢ are the parts between nodes D 302 and H 316. This is because node D 302 has been identified as the node with the greatest input overlap, and node H 306 has been identified as the node with the greatest output overlap of sub-frame F′, wherein F′ is made of nodes D 302 to J 307. Two nodes, F 304 and G 305 would effectively be replaced by Cᵢ, so the value m′=2, and the CN score can be determined to be:

N(Cᵢ)=|(L_{Ci}−(L_{f}∪L_{G}))∪(S_{Ci}−(S_{F}∪S_{G}))|×2

The example calculation of CN score in FIG. 3 requires that the primary data structure and candidate documents have been correctly tagged with the different categories of input, output, process and system tags. However, in some embodiments, not all of these tags are available. Providing all of these tags may require too much processing power and computer resources, for example, or the tags cannot be determined to a sufficient degree of accuracy.

In the case of “incomplete” document tags, other tag comparison techniques could be used to determine a CN score. In one embodiment, this would comprise a comparison technique to compare the candidate document and flowchart tags, irrespective of their tag categorisation, to determine the number of flowchart nodes affected by a candidate document base on their overlapping ranges.

The example algorithm for determining CN score described above are only example algorithms, and many more are envisioned utilising the framework presented herewith. For example, weights could be assigned to certain tags or categories (e.g. L or S tags), and these weightings could be used to increase or decrease the CN score accordingly.

A CN score N(Cᵢ) may be determined for each candidate document Cᵢ. The candidate document with the highest CN score may be presented to the user, or a list of candidate documents with the highest scores may be presented instead. The user may be presented with the selected documents, as well as the processes that can be replaced in the primary document, and what candidate features could replace those processes. The user may decide which of these suggestions to use, and then manually combine the teachings to arrive at a new and improved process.

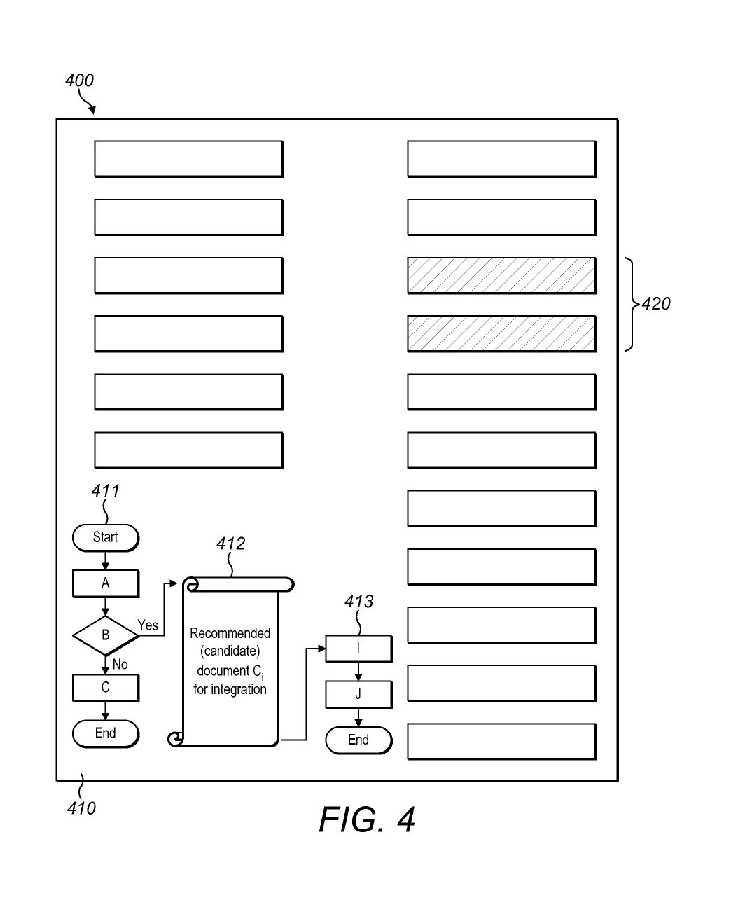

The proposed system may automatically select one or more candidate documents with the highest CN score and generate new documents merging these selected candidate documents with the primary document. FIG. 4 illustrates the result of such a merger.

Upon selection of a highest ranked candidate document Cᵣ, the proposed solution may identify the sub-flowchart Fr of the primary data structure that would be replaced by the novel features disclosed in Cᵣ. The proposed solution may then remove all text portions in the document 400 directed to replaced process steps, and in its place insert text portions 420 describing the novel features outlined in the recommended candidate document Cᵣ. These features may be taken from the feature set [Iᵣ, Oᵣ, Lᵣ. Sᵣ], for example.

The proposed solution may replace a figure of the original flowchart with a modified FIG. 410 that substitutes features of the original flowchart with novel features of the recommended candidate document Cᵣ.

In the example embodiment shown in FIG. 4, novel features of Cᵣ have been inserted 412 into the flowchart 410 to replace original nodes D to H, and leaving the remaining nodes 411 and 413.

Generated document 400 may be provided as a completed document to the user, or as a template for the user to add to and modify. Several of these documents 400 may be automatically generated for the user to choose from.

When the original primary technical document is a patent, the newly generated document 400 may be a new patent that could even relate to a novel and inventive invention should the updated disclosure satisfy the necessary requirements of patentability. When the original document is a patent, this system can be used for generating several new inventions related to existing patent pools and to update existing patents with new technology.

For example, in the case of patent portfolio, the proposed solution may extract embedded flowcharts and their corresponding text from the input patent documents. In patent applications, each flowchart node is assigned a block number, so it is then possible to precisely retrieve text form the patent ‘Description’ text corresponding to specific flowchart nodes. Given the consistent formatting and layout of patent documents, the proposed solution is particularly suited to performing bulk analyses on patent documents.

The proposed solution may then annotate flowchart nodes with tags extracted from the patent description text. Once the primary data structure has been constructed, the proposed solution may monitor new technology articles and documents, and extract features summarizing the documents.

The proposed solution may then compute the CN score of each document. In this example embodiment the CN score would characterise the “inventiveness” of the new document with respect to the existing patent in terms of semantic differentiation with respect to the relevant flowchart nodes. The proposed system may then rank documents by their inventiveness, namely their CN scores.

The proposed solution may subsequently proceed to generate templates for new (related) patents. This generation may involve selecting the document with the highest CN score, and use the input patent as a template of the new invention by replacing nodes of the input patent with the new document's features.

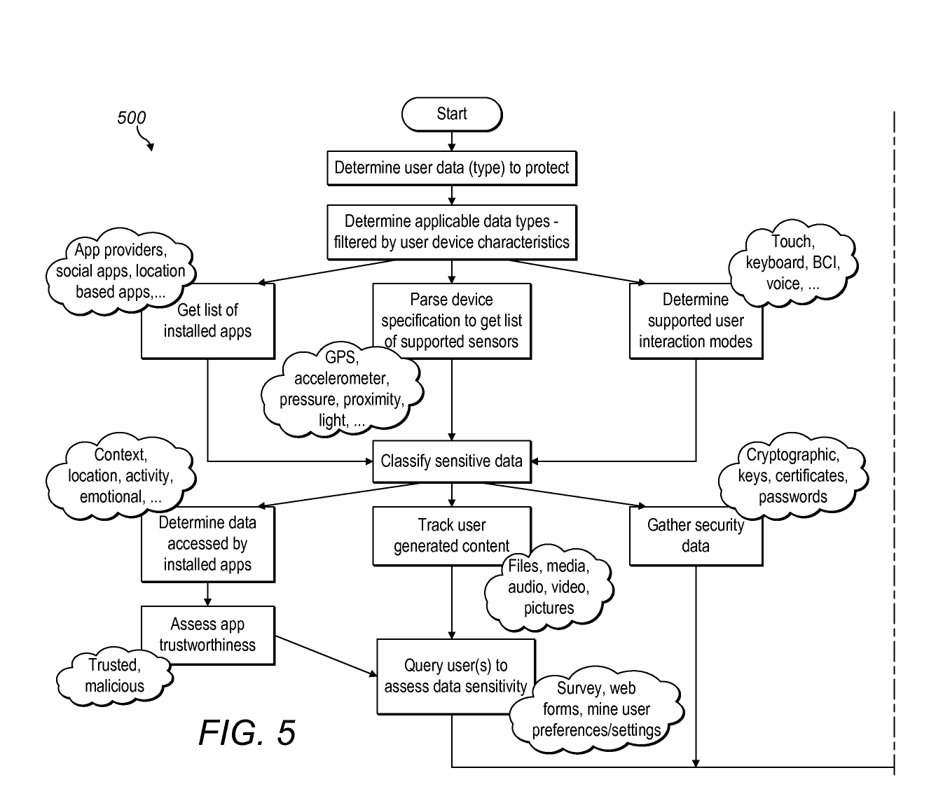

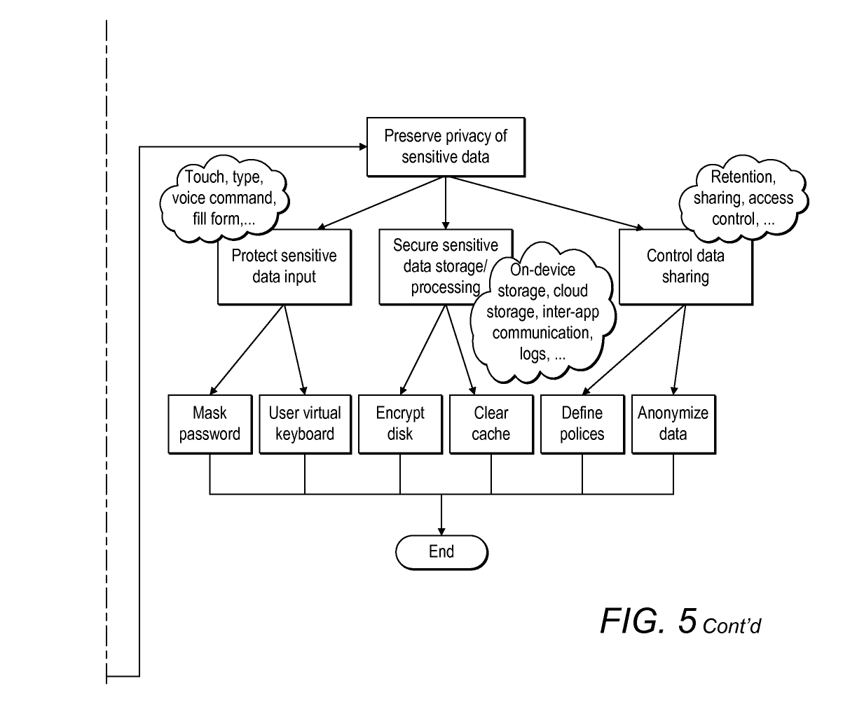

FIGS. 5 to 8 illustrate a worked example of automatically finding improvements of a field, in this case ‘mobile privacy’, using an example embodiment of the proposed solution.

FIG. 5 shows a primary data structure 500 representing a solution flowchart for the field of ‘mobile privacy’. In this example embodiment the primary data structure is constructed by extracting different flowcharts from a plurality of input patents to form the aggregate flowchart 500.

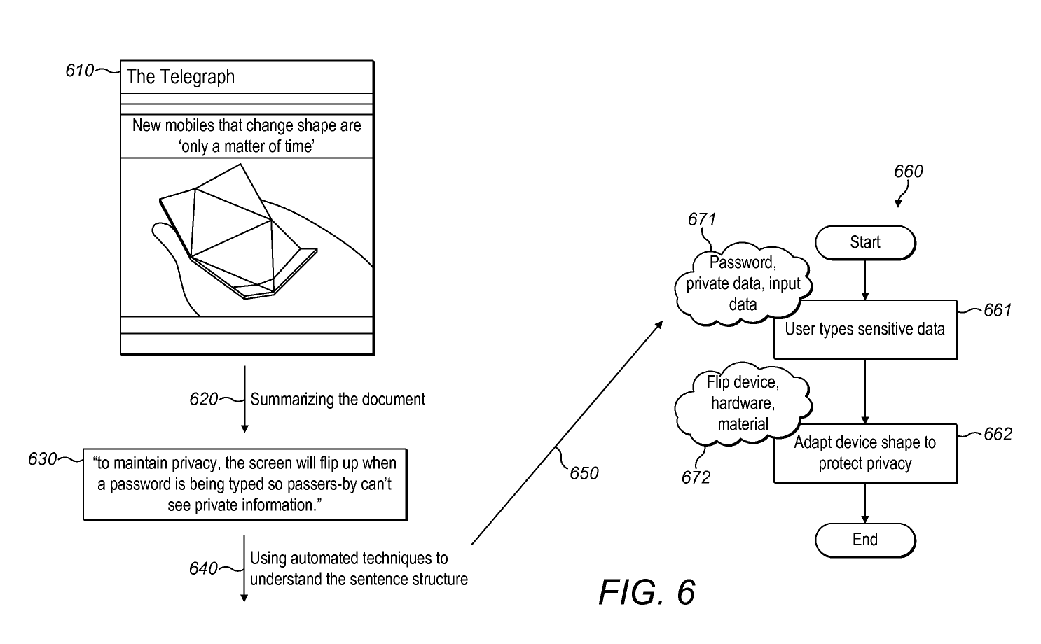

FIG. 6 illustrates the extraction of information from an example candidate document. In this example, candidate document 610 is a news article describing a new technology available. This candidate document 610 may have been acquired by the proposed system by automatically checking all newly published news articles from certain source or containing certain key words, such as ‘mobile’.

At step 620, the proposed system may summarise the candidate document 610 using known document summarisation techniques. Such summarisation techniques allow the disclosure of the candidate document 610 to be reduced to a much shorter disclosure of the document. This shorter disclosure would be both easier to store and require less processing power to analyse. The result of this summarisation is shown in 630, which reduces the article to a single core concept: “to maintain privacy, the screen will flip up when a password is being types so passers-by can't see private information”.

At a further step 640, the proposed system uses automated techniques to analyse the sentence structure to extract features from the document that can be categorised. Semantic substitution may be subsequently performed to generalise the extracted keywords and allow for easier comparisons between documents. For example, the word ‘password’ may be abstracted to ‘sensitive data’, while ‘flip up’ could be changed to ‘change device shape’.

At step 650, the proposed system may construct a data structure (flowchart) 660 of the key concepts identified in document 610. The two steps identified are that “User types sensitive data” at node 661, which is connected to node 662 with the process step “Adapt device shape to protect privacy” 662.

In addition to identifying process steps for nodes, the proposed solution may also tag these process steps 661 and 662 with associated tags 671 and 672. In some embodiments, the tags generated may not be categorised into input, output, process and system tags, but may instead comprise any keywords identified. For example, node 661 is tagged with tags “password”, “private data” and “input data” 671, while node 662 is tagged with tag “flip device”, “hardware”, and “material”.

While the generalised tags 671 and 672 shown in the data structure 660 may not provide the same organised construction as other embodiments described, the presence of these tags may still simplify any subsequent attempted mappings onto the primary data structure. In some embodiments, the improved performance of using precise tags is less than the improved performance of utilising simpler tagging mechanisms.

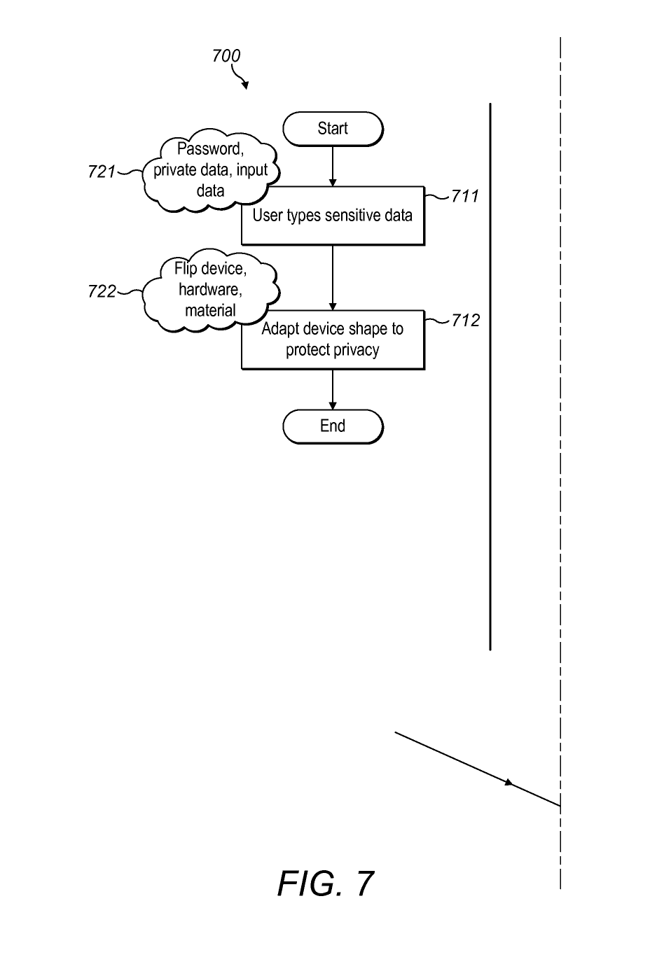

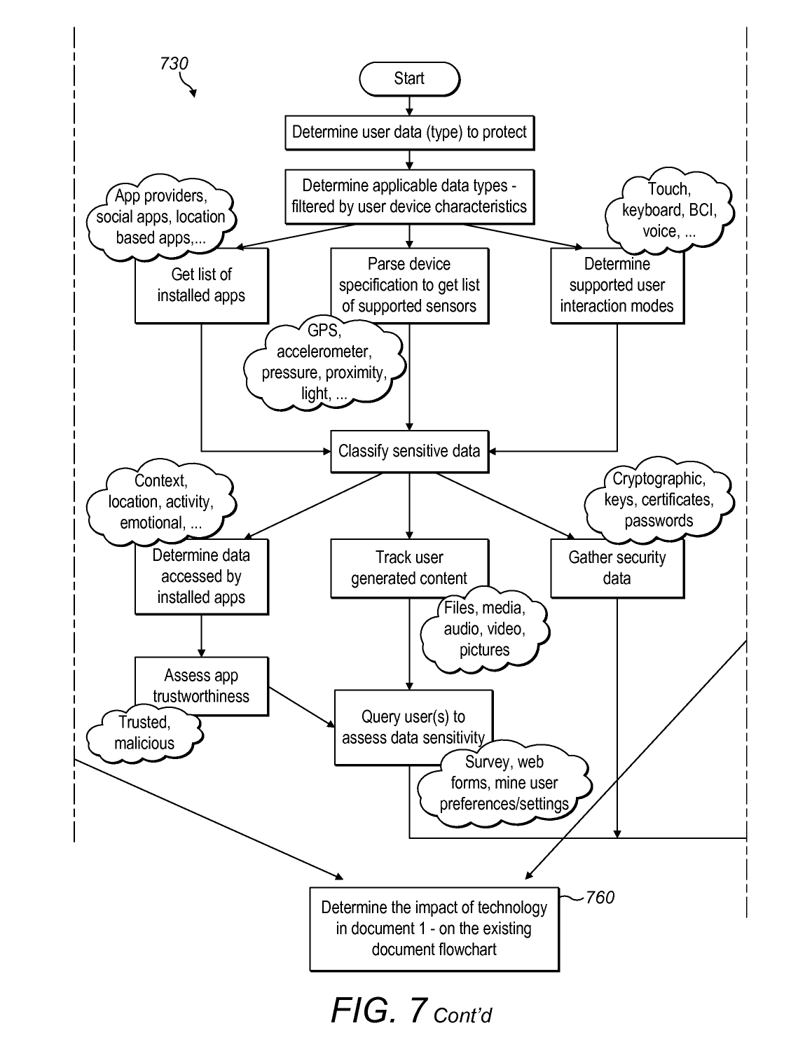

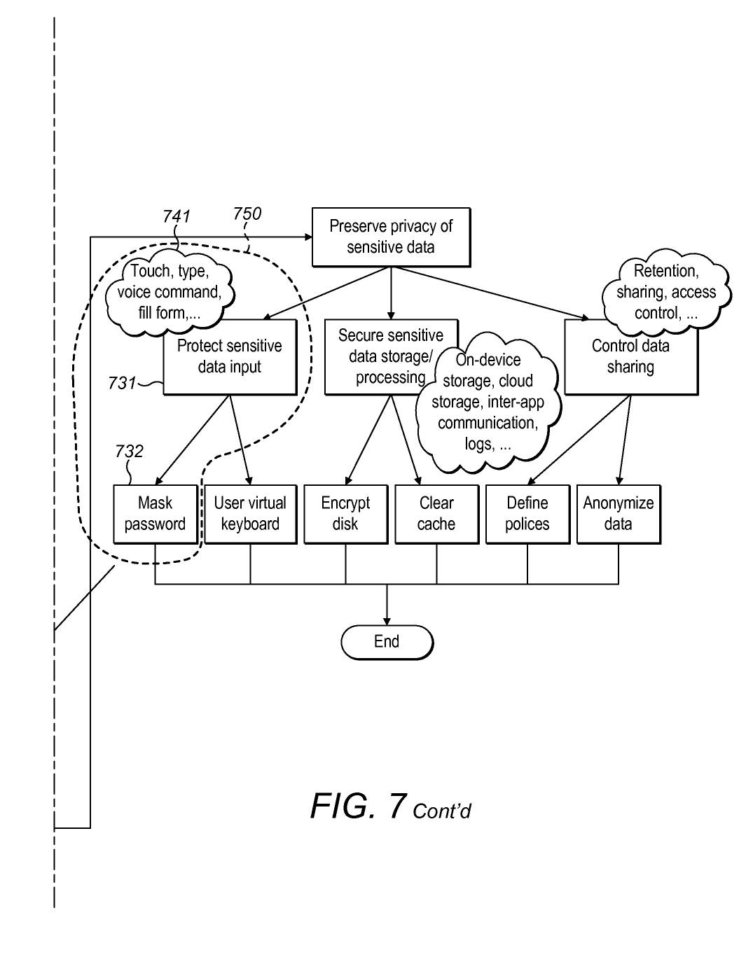

FIG. 7 shows how the extracted contents 700 of a candidate document can be compared to the primary data structure 730 to determine if any of the features of the candidate document can be inserted into the primary data structure 730. At step 760, analysis is performed on the nodes in the two data structures 700 and 730, and the proposed system may determine that the impact of the technology in data structure 700 on the existing data structure 730 is the two nodes 731 and 732 in the box 750. The proposed system may identify that both node 711 and node 731 have processes directed towards sensitive data, while both node 712 and node 732 provide a means for preserving sensitive data.

With more structured tagging, both the “User types sensitive data” node 711 and the “Protect sensitive data input” node 741 may have had an input tag “sensitive data”, while both the “Adapt device shape to protect privacy” node 712 and the “Mask password” 732 node may have an output tag of “privacy preserved”. These explicitly matched input and output tags may indicate to the system that these nodes can be combined.

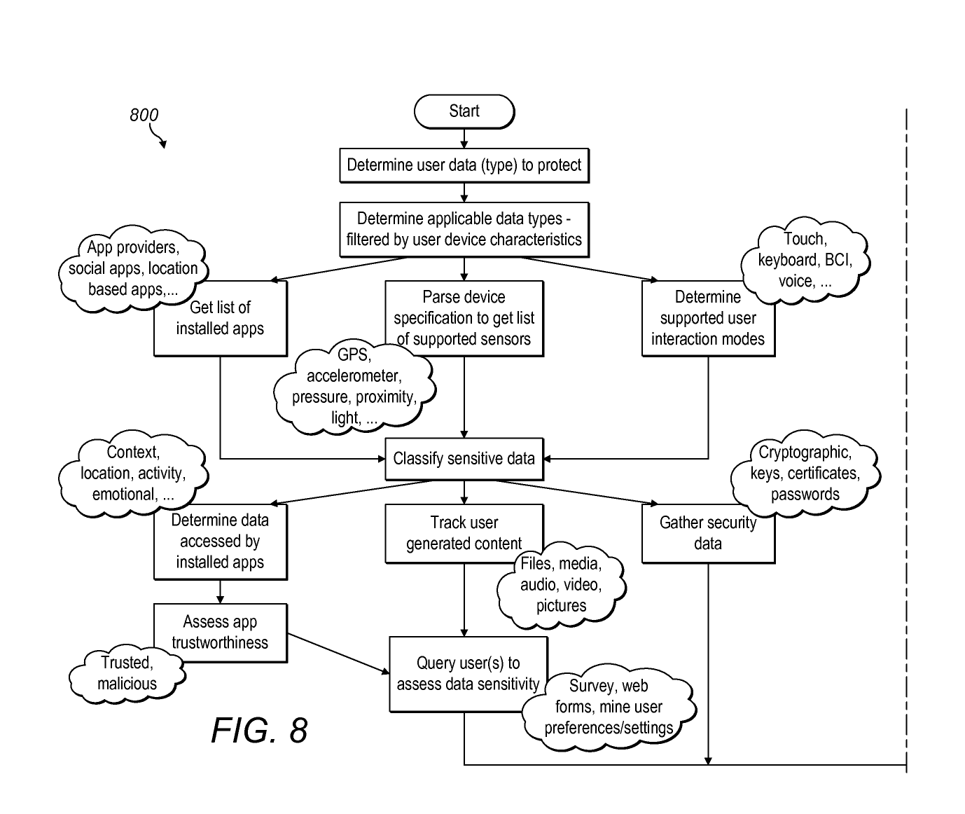

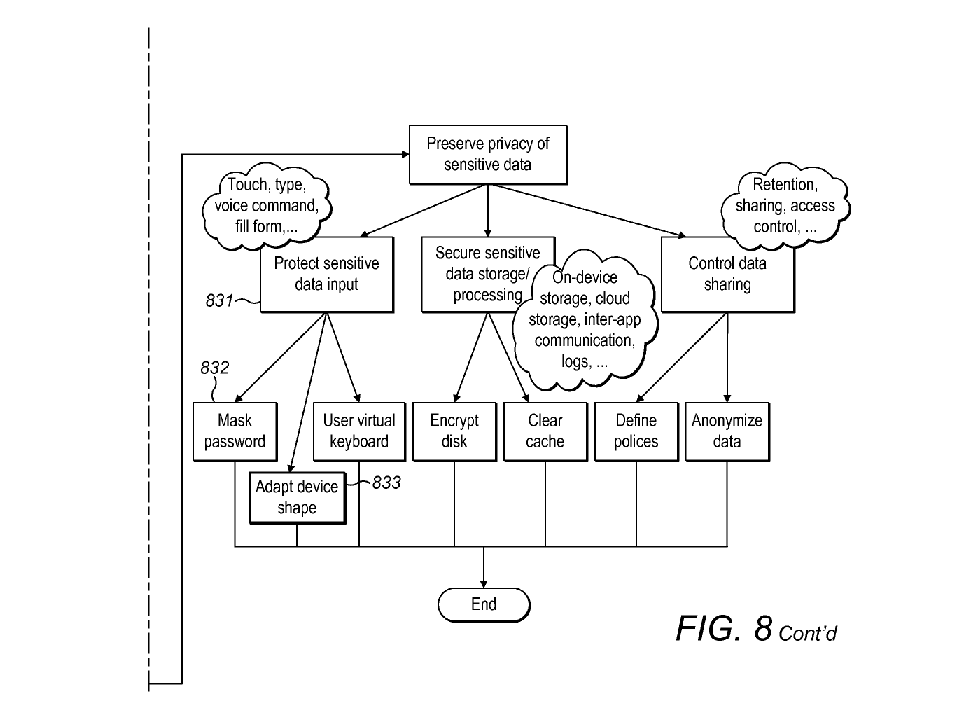

FIG. 8 shows an updated primary data structure 800 after insertion of features from the candidate document. The “Adapt device shape” node 833 from the candidate document may either be inserted to replace the “Mask password” 832 node or as an alternative to it. Given that primary data structure 800 is an aggregate of available mobile privacy technologies, in this case, the node 833 is provided as an additional node, rather than a replacement one.

In this example, the resulting primary data structure 800 may not be a candidate for a patentable invention, as the original teaching of adapting device shapes for privacy is already disclosed in candidate document 610.

Nevertheless, in this example embodiment, the user is now provided with an improvement to their mobile device products that they may not have been aware of had the system not automatically identified this improvement.

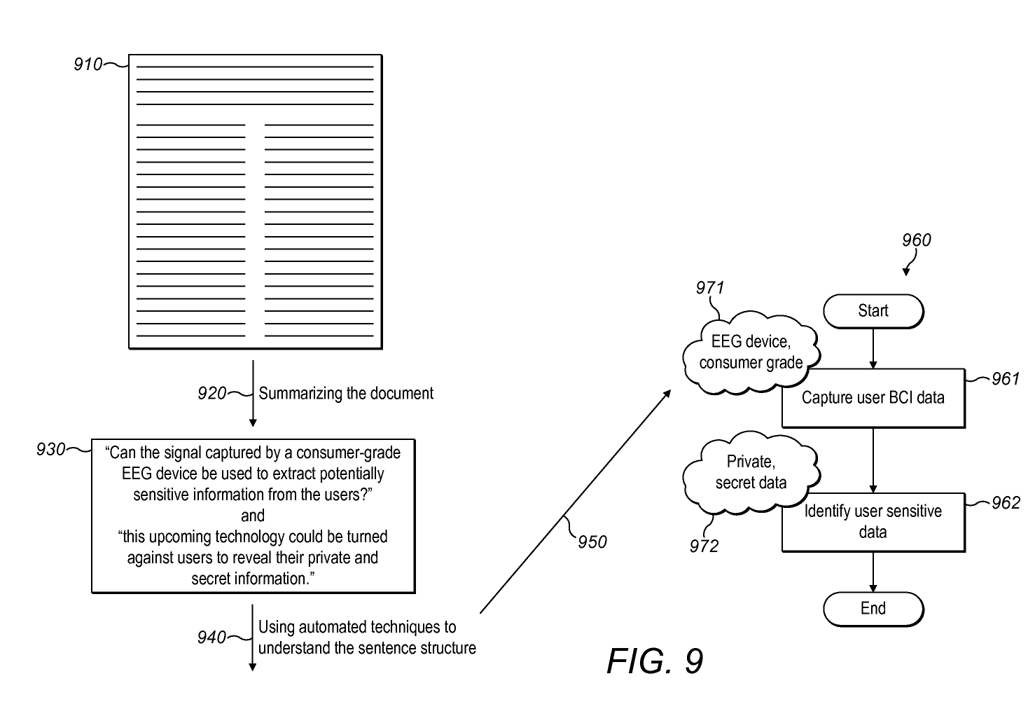

FIGS. 9 to 11 illustrate a further worked example of automatically finding improvements of the example field of ‘mobile privacy’ using an embodiment of the proposed system.

FIG. 9 illustrates the extraction of information from an example candidate document. In this example, candidate document 910 is an academic publication in an unrelated field with the title “On the Feasibility of Side Channel Attacks with Brain-Computer Interfaces”. This candidate document 910 may not be an article that a skilled person in the field of mobile telecoms would be aware of, but in the proposed system, such a document may be monitored by and considered as a candidate document.

At step 920, the proposed system may summarise the candidate document 910 using known document summarisation techniques. The result of this summarisation is shown in 930, which reduces the article to simpler core concepts: “Can the signal captured by a consumer-grade EEG device be used to extract potentially sensitive information from the users” and “this upcoming technology could be turned against users to reveal their private secret information”.

At a further step 940, the proposed system uses automated techniques to analyse the sentence structure in order to extract features from the document that can be categorised. Semantic substitution may subsequently be performed to generalise the extracted keywords and to allow for easier comparisons between documents. For example, the acronym ‘EEG’ (electroencephalogram) may be changed to a more generic ‘BCI’ (brain-computer interface), and the word ‘reveal’ may be provided with ‘mine’ ‘identify’ and ‘classify’ as synonyms.

At step 950, the proposed system may construct a data structure (flowchart) 960 of the key concepts identified in document 910. The two steps identified are “Capture user BCI data” at node 961, which is connected to node 962 with the process step “Identify user sensitive data” 962. In addition to identifying process steps for nodes, the proposed solution may also tag these process steps 961 and 962 with associated tags 971 and 972. For example, node 961 is tagged with tags “EEG device” and “consumer grade” 971, while node 962 is tagged with tag “private” and “secret data” 972.

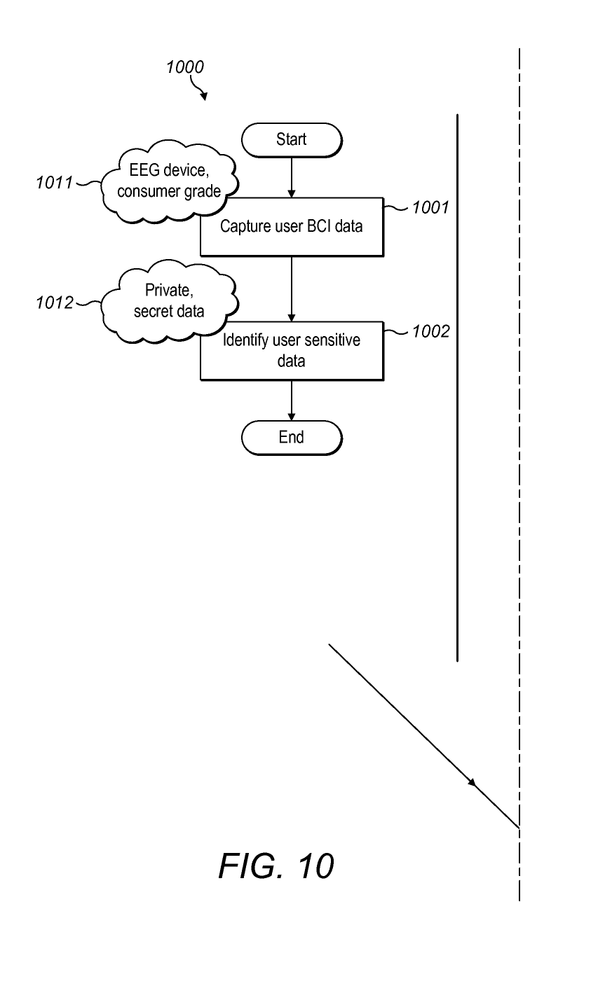

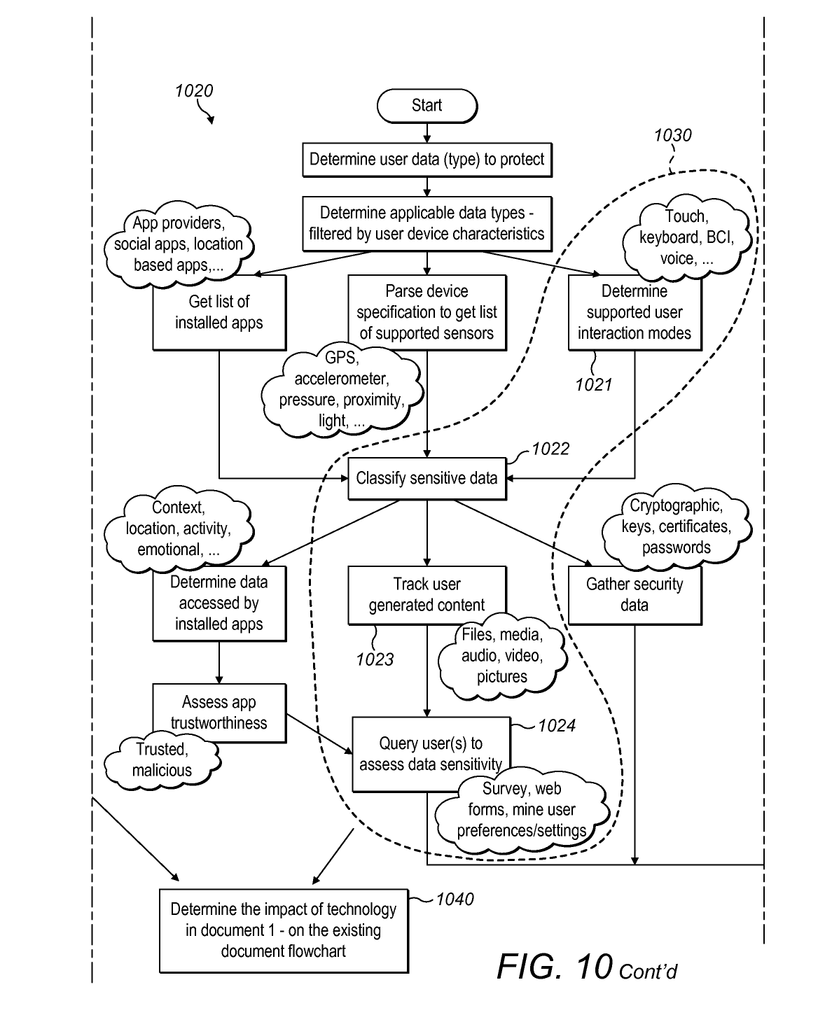

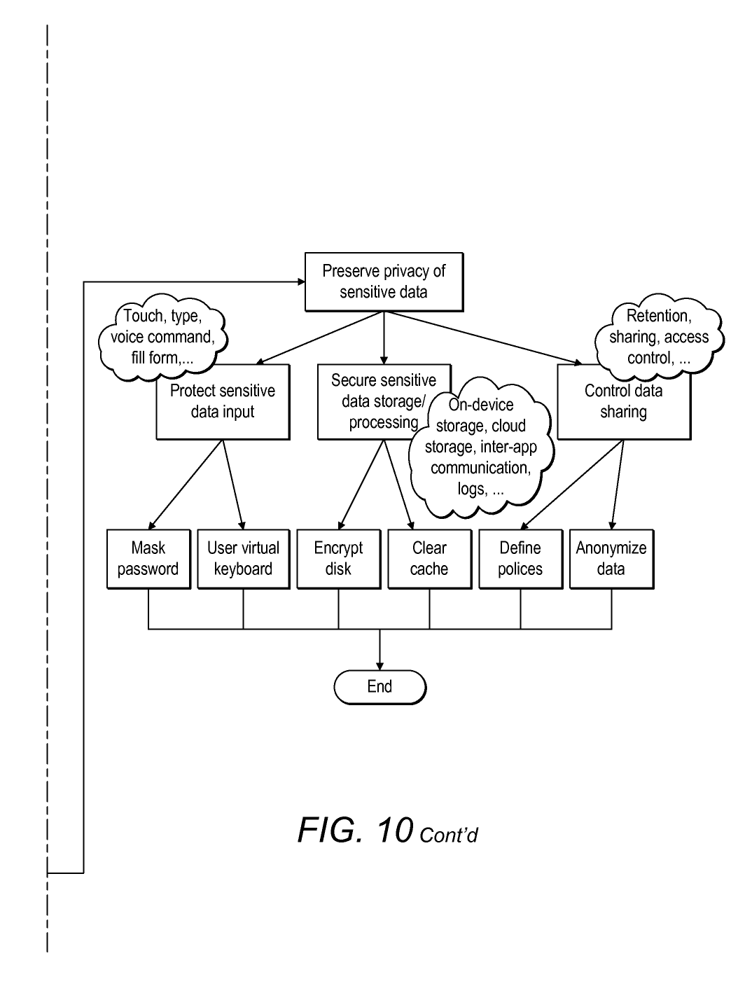

FIG. 10 shows how the extracted contents 1000 of a candidate document may be compared to the primary data structure 1020 to determine if any of the features of the candidate document are suitable for insertion into the primary data structure 1020. At step 1040, analysis is performed on the nodes in the two data structures 1000 and 1020, and the proposed system may determine that the impact of the technology in data structure 1000 on the existing data structure 1030 is the nodes 1021, 1022, 1023 and 1024 in the box 1030. Such a determination could be made by scanning the nodes of the primary data structure 1020 for process steps and tags that match those of the candidate data structure 1000. Alternatively, a more exhaustive approach of determining CN scores may be performed instead.

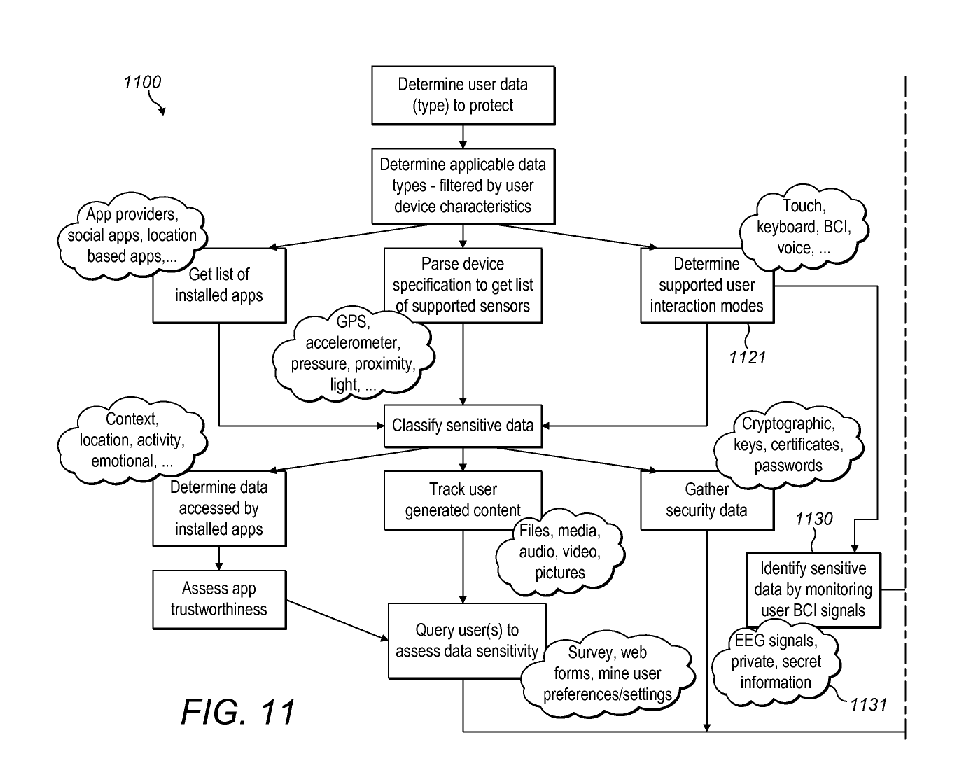

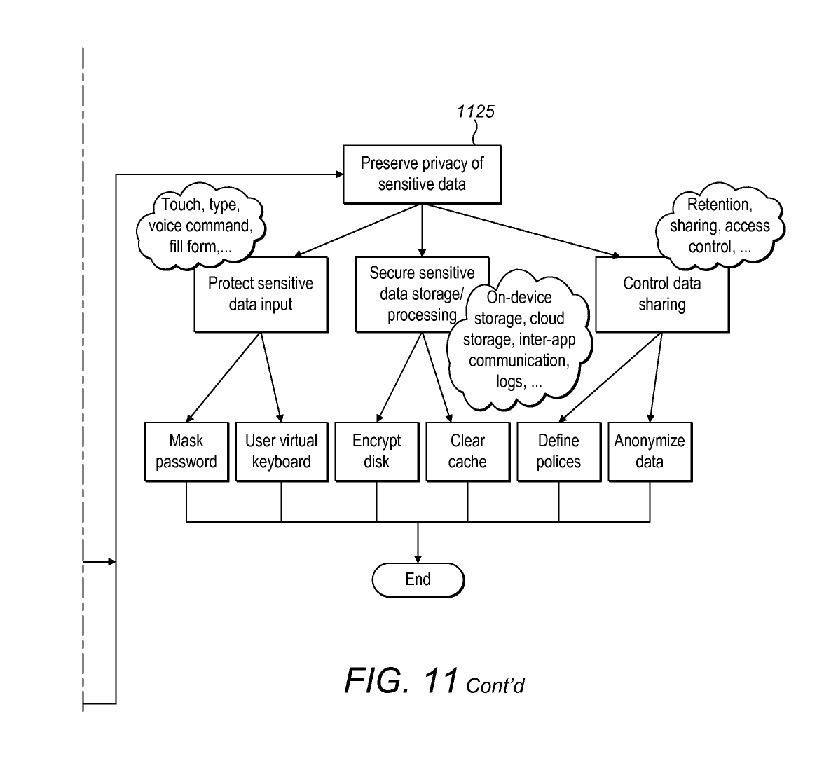

FIG. 11 shows an updated primary data structure 1100 after insertion of features from the candidate document. The “Identify sensitive data by monitoring user BCI signals” node 1130 from the candidate document may either be inserted to replace the sequence of nodes identified in step 1040 of FIG. 10, or as an alternative to the nodes. As such, the user is provided with a hitherto unknown combination of features, thereby providing an incremental improvement over existing technology.

The examples provided in FIGS. 5 to 11 are simple examples to illustrate that the proposed system can be very flexible in the way it is implemented. While determining CN scores using precisely categorised tags may provide a robust framework, the proposed solution may also provide good results with generalised tagging. Similarly, while embodiment comprises the calculation of CN scores may store the features of candidate documents as unlinked processes, other embodiments may construct full data structures for the candidate documents as well as the primary documents.

It is to be understood that the present disclosure includes permutations of combinations of the optional features set out in the embodiments described above. In particular, it is to be understood that the features set out in the appended dependent claims are disclosed in combination with any other relevant independent claims that may be provided, and that this disclosure is not limited to only the combination of the features of those dependent claims with the independent claim from which they originally depend.

1. A computer-implemented method comprising:
extracting process steps disclosed in a primary document and extracting candidate process steps disclosed in one or more candidate documents;
constructing a primary data structure corresponding to the primary document, wherein the primary data structure comprises interconnected nodes and each node corresponds to an extracted process step disclosed in the primary document;
identifying one or more candidate processes to combine with the primary data structure; and
inserting the one or more identified candidate process steps into the primary data structure.

2. The method of claim 1, wherein said identifying comprises determining the uniqueness of candidate process steps with respect to nodes in the primary data structure.

3. The method of claim 2, wherein determining the uniqueness of candidate process steps comprising tagging each node in the primary data structure and each candidate process step with a logic step, and calculating the number of unique logic steps in a the candidate process steps compared to the logic steps in the nodes in the primary data structure.

4. The method of claim 1, wherein the inserting one or more candidate process steps comprises inserting details of the candidate process steps into one or more nodes of the primary data structure.

5. The method of claim 1, wherein the inserting one or more candidate process steps comprises forming new nodes corresponding to the candidate process steps and interconnecting said new nodes with the nodes in the primary data structure.

6. The method of claim 5, wherein interconnecting said new nodes with the nodes in the primary data structure comprises replacing a sequence of one or more nodes in the primary data structure with the new nodes.

7. The method of claim 6, wherein said identifying comprises determining the number of nodes in the sequence of nodes in the primary data structure replaced by the new nodes.

8. The method of claim 6, further comprising determining input and output data for each extracted process step and each candidate process step, and for each candidate document:
selecting a start node in the primary data structure corresponding to the process step having a greatest overlap of input data with input data in the candidate process steps;
selecting an end node in the primary data structure corresponding to the process step having a greatest overlap of output data with output data in the candidate process steps;
wherein the sequence of nodes defined by the selected start node and end node is the sequence of nodes replaced by the new nodes.

9. The method of claim 8, wherein the determining input and output data for each extracted process step and each candidate process step further comprises tagging each extracted process step and each candidate process step with input and output data.

10. The method of claim 1, wherein said identifying one or more candidate process steps comprises calculating a score for each of the one or more candidate documents, and identifying one or more candidate process steps from the candidate document with a highest score.

11. The method of claim 10, wherein the score can be based on any one or more of: the uniqueness of process steps, and the number of nodes in the primary document replaceable by process steps.

12. The method of claim 1 further comprising:
after inserting the one or more candidate process steps into the primary data structure, generating a new document disclosing process steps corresponding to the primary data structure.

13. The method of claim 1, further comprising:
after inserting the one or more candidate process steps into the primary data structure, outputting the primary data structure as a candidate innovation.

14. The method of claim 1, wherein said the extracted process extracting process steps disclosed in the primary document comprises performing image analysis on a technical drawing in the primary document, wherein said technical drawing is preferably a flowchart.

15. The method of claim 1, wherein the primary document is a patent document, and the method further comprises:
receiving a plurality of patent documents; and
repeating the method of any preceding claim on each patent document as a primary document.

16. A computer system comprising:
one or more processors; and
memory comprising instructions which when executed by the one or more processors cause the computer system to:
extract process steps disclosed in a primary document and extracting candidate process steps disclosed in one or more candidate documents;
construct a primary data structure corresponding to the primary document, wherein the primary data structure comprises interconnected nodes and each node corresponds to an extracted process step disclosed in the primary document;
identify one or more candidate processes to combine with the primary data structure; and
insert the one or more identified candidate process steps into the primary data structure.

17. A non-transitory computer readable medium having computer executable instructions stored thereon for implementing a method, the method comprising:
extracting process steps disclosed in a primary document and extracting candidate process steps disclosed in one or more candidate documents;
constructing a primary data structure corresponding to the primary document, wherein the primary data structure comprises interconnected nodes and each node corresponds to an extracted process step disclosed in the primary document;
identifying one or more candidate processes to combine with the primary data structure; and
inserting the one or more identified candidate process steps into the primary data structure.
